(19) United States
(12) Patent Application Publication
(10) Pub. No.: US 2016/0337353 A1
(43) Pub. Date: Nov. 17, 2016

(54) SYSTEM AND METHOD FOR MULTI-FACTOR AUTHENTICATION

(71) Applicant: Interactive Intelligence Group, Inc., Indianapolis, IN (US)

(72) Inventor: Benjamin J. Coats, Columbia, SC (US)

(73) Assignee: Interactive Intelligence Group, Inc.

(21) Appl. No.: 14/708,933

(22) Filed: May 11, 2015

(51) Int. Cl. H04L 29/06; H04W 12/06; G06F 21/31

(52) U.S. Cl. CPC H04L 63/0884; G06F 21/31; H04W 12/06

(57) ABSTRACT

A system and method are presented for multi-factor authentication comprising the authentication of users, physical locations, and schedules. A combination of the physical location of a user and user devices can be utilized to bypass multi-factor authentication. Devices may be GPS-enabled and/or network connected in order to determine the location of the device and if the device and the credentials are within the authorized location. Scheduling factors may also be considered such that if a user is not within a particular space-time region, multi-factor authentication may not be by-passed. Time intervals may be approved based on authorized schedules for a location, authorized schedules for a device, and authorized schedules for the credentials.

### BACKGROUND

The present invention generally relates to systems and methods of distributed platforms employing a service-oriented architecture, as well as information security. More particularly, the present invention pertains to the authentication of users and authorization of a physical location.

### SUMMARY

A system and method are presented for multi-factor authentication comprising the authentication of users, physical locations, and schedules. A combination of the physical location of a user and user devices can be utilized to bypass multi-factor authentication. Devices may be GPS-enabled and/or network connected in order to determine the location of the device and if the device and the credentials are within the authorized location. Scheduling factors may also be considered such that if a user is not within a particular space-time region, multi-factor authentication may not be by-passed. Time intervals may be approved based on authorized schedules for a location, authorized schedules for a device, and authorized schedules for the credentials.

In one embodiment, a method is presented for authenticating a user in a system comprising at least a user, a user device, a secured resource, an authentication service, and a user datastore, the method comprising the steps of: obtaining, by the secured resource from the user, credentials that assert an identity of the user; sending, by the secured resource to the authentication service, the credentials from the device; providing, by the user datastore to the authentication service, an encrypted version of credentials associated with the user in the system and validating, by the authentication service, the credentials that have been entered with the encrypted version of credentials; providing, by the user datastore to the authentication service, previously selected attributes for the user; verifying, by the authentication service, that the user meets criteria of the previously selected attributes, wherein, if the user meets criteria of the previously selected attributes, bypassing further authentication, and if the user is not within the meets criteria of the previously selected attributes, invoking further authentication.

In another embodiment, a method is presented for authenticating a user in a system comprising at least a user, a device, a secured resource, an authentication service, a user datastore, and a transmitter, the method comprising the steps of: obtaining, by the secured resource from the user, credentials that assert an identity of the user; sending, by the secured resource to the authentication service, the credentials from the device; providing, by the user datastore to the authentication service, an encrypted version of credentials associated with the user and validating, by the authentication service, the credentials that have been entered with the encrypted version of credentials; providing, by the user datastore to the authentication service, attributes for the user; verifying, by the authentication service with the transmitter, the attributes for the user, wherein, if the user meets criteria for the attributes, bypassing further authentication, and if the user does not meet criteria for the attributes, invoking further authentication.

### BRIEF DESCRIPTION OF THE DRAWINGS

FIG. 1 is a flowchart illustrating an embodiment of a process for multi-factor authentication.

FIG. 2 is a flowchart illustrating an embodiment of a process for multi-factor authentication.

FIG. 3 is a diagram illustrating an embodiment of multi-factor authentication.

FIG. 4 is a diagram illustrating an embodiment of multi-factor authentication.

FIG. 5 is a diagram illustrating an embodiment of multi-factor authentication.

FIG. 6 is a diagram illustrating an embodiment of multi-factor authentication.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Generally, access restrictions to a computing system may be broken into two components: authentication and authorization. Authentication is concerned with ensuring the remote computing resource can verify a user. Authorization determines what a user is allowed to see or do within a system and is often referred to as “access control”. Consider an example comprising four users with system access. For example, authorization is a component of security that enables user 1 to issue a new insurance policy while user 2 can only view documents created as a result of the actions of user 1. User 3 can log into an enterprise workforce management application while on the company network, but user 4 is denied that level of access. A present embodiment described within is concerned primarily with authentication, but may also incorporate both authentication and authorization. In an example, a physical location that a remote user is at may be authorized and granted certain privileges that another location may not have.

As information security has evolved, general models of authentication have emerged. Generally, a model asserts that user authentication may be broken into three categories (also known as factors). The factors comprise something a user knows, something a user has, or something a user is. For example, “something a user knows” may comprise secrets, passwords, sensitive information, predefined challenge question responses, etc. “Something a user has” may comprise an object that is physically in the user's possession. The presence alone of this object identifies the user and can range from immigration papers to an RFID card or mobile device. “Something a user is” may comprise aspects of the user's appearance or bio-physical makeup that uniquely identifies the user (e.g., fingerprints, retinal scans, biomarkers, etc.).

Any of the aforementioned factors can stand alone, however each has its own implicit risks. Thus, more information may be required of a user. Each additional piece of information significantly reduces the chance of a malicious device or program being able to correctly guess the answer. However, with each additional question, an additional piece of data must be remembered by the user. This results in a greater likelihood of a user forgetting an answer and having to request a reminder or reset, resulting in a strong negative impression of the user experience. Risk is also increased as a user may want to commit information to writing as an aid.

Multiple pieces of information are not an efficient or, in some case, a secure solution. Security surrounding a resource may be strengthened by utilizing multiple factors as opposed to pieces of information, without having as negative an impact on user convenience and overall security.

In practice, two-factor authentication is commonly applied. The first factor may be a piece of information while the second factor is something the user has (e.g., a mobile device or valid email account). After the user attempts to authenticate to a secure resource and has supplied a valid username-passphrase combination, the authentication service will send a message to a device the user has previously configured or associated with the profile. The message may be a text message to a mobile device or an email to a user's previously supplied email address. The message contains a randomly generated key that the user must provide to the system before being allowed to proceed. An authentication service confirms that the user not only knows a piece of information that helps to identify them, but also has something that provides further proof that the impersonation and the person are one. Despite the prevalence of this authentication paradigm, it is still inherently more time-consuming and requires more action on a user's part than a simple authentication based on credentials. It is a blanket solution with no built-in provision for flexibility in multi-factor authentication. The method is not able to adapt based on the exact scenario in play and does not take into consideration the fact that the same exact transaction, executed in two different contexts, may involve two entirely different levels of potential impersonation risk.

Securing a resource balances security with user convenience. Users typically encounter the same sequence of operations every time an attempt is made to access a resource. Risk and threat assessments are made. Designs are produced to match the threat of compromise and the potential consequences of such compromise, to a solution that reduces the risk to an acceptable level while not discouraging use of the resource.

An alternative is needed to these static authentication schemes for resources requiring stronger security than single-factor authentication provides, yet have broad enough user bases for the user experience to be taken into careful consideration.

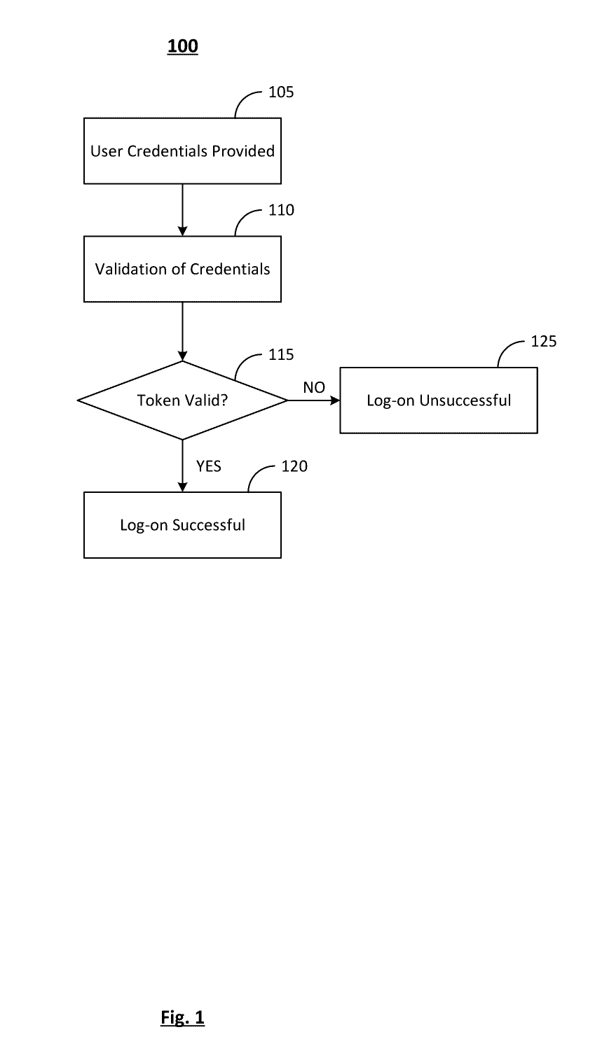

FIG. 1 is a flowchart illustrating an embodiment of a process for multi-factor authentication, indicated generally at 100. As described previously, FIG. 1 illustrates the general process of multi-factor authentication of a user to a resource.

In operation 105, a user provides credentials. For example, a user may provide a login to a secured resource such as a user name or user ID and a passphrase. Control is passed to operation 110 and process 100 continues.

In operation 110, the user's credentials are validated. For example, a secured resource validates the provided credentials with those associated with the user profile in a datastore. Encrypted credentials may be obtained for the User from a user datastore by the secured resource. The encrypted credentials from the user datastore may be compared against those provided by the user and declared valid. The secured resource may also obtain the user's profile from the user datastore. The user profile may contain an object such as a mobile number or email address.

An authentication token may be generated by the secured resource and sent to the user. The secured resource sends a persistent authentication token to the user datastore. In an example, an SMS message may also be sent to the SMS service to be transmitted to the contact information previously provided by the user containing the generated authentication token. The secured resource may then notify the user that an authentication then has been sent upon which the user will receive a message with this token. Control is passed to operation 115 and the process 100 continues.

In operation 115, it is determined whether or not the token provided to the secure resource by the user is valid. If it is determined that the token is valid, control is passed to operation 120 and the process 100 continues. If it is determined that the token is not valid, control is passed to operation 125 and the process continues.

The determination in operation 115 may be made based on any suitable criteria. For example, the user receives the authentication token via SMS or email or other suitable means. The token is submitted to the secured resource, by the user, and compared with the persistent authentication token previously generated in operation 110.

In operation 120, the authentication token is declared valid and the user is successfully logged-in.

In operation 125, the authentication token is not declared valid user is denied access.

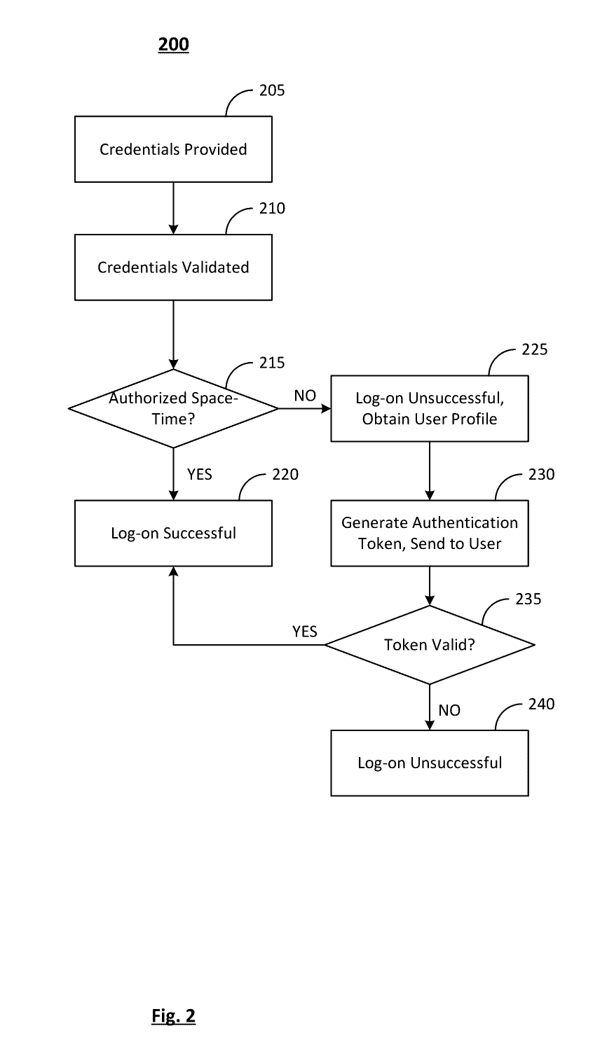

FIG. 2 is a flowchart illustrating an embodiment of a process for multi-factor authentication, indicated generally at 200. In FIG. 2, an example of a combination of authentication and authorization access restrictions is provided with context-dependent factor bypass employed.

In operation 205, a user provides credentials. For example, a user may provide a login to a secured resource such as a user name or user ID and a passphrase. A secured resource may comprise an application, such as a web-based application, a Windows application, a native iOS/Android application, or any other application to which security is being restricted. Control is passed to operation 210 and process 200 continues.

In operation 210, the user's credentials are validated. For example, a secured resource validates the provided credentials with those associated with the user profile in a datastore. Encrypted credentials may be obtained for the user from a user datastore by the secured resource. The encrypted credentials from the user datastore may be compared against those provided by the user and declared valid. The secured resource may also obtain the user's profile from the user datastore. The user profile may contain an object such as a mobile number or email address.

Encrypted credentials are obtained, validation is passed. The encrypted credentials are compared to the login credentials and if they meet the criteria, declared valid. Control is passed to operation 215 and process 200 continues.

In operation 215, it is determined whether or not the user is in an authorize space-time cube. If it is determined that the user is not in an authorized space-time region, control is passed to operation 225 and process 200 continues. If it is determined that the user is in an authorized space-time cube, control is passed to operation 220 and process 200 continues.

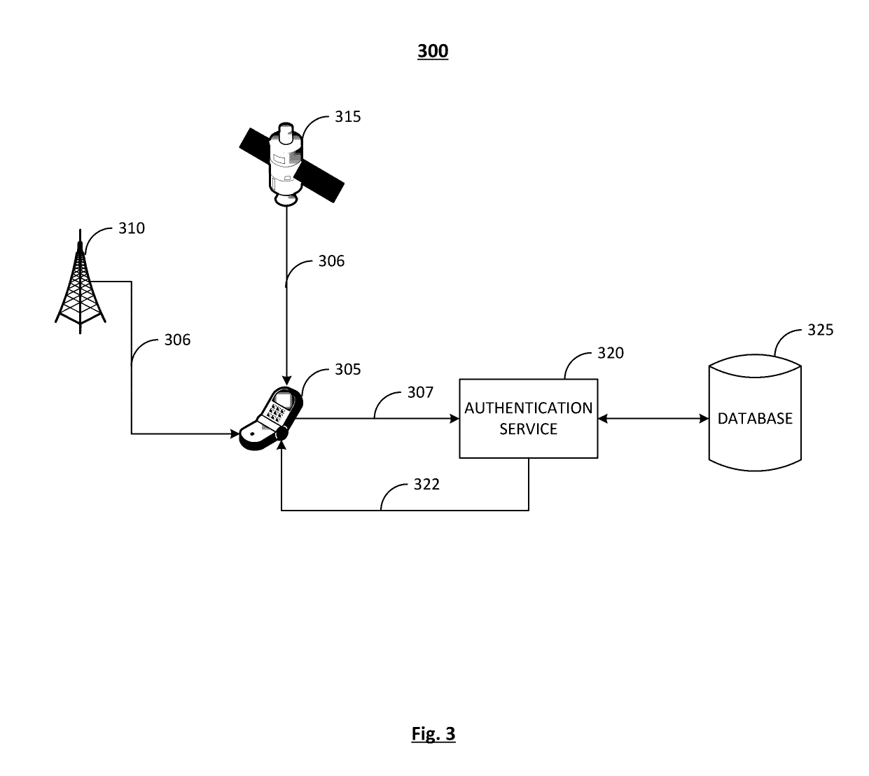

The determination in operation 215 may be made based on any suitable criteria. For example, authorized locations may be obtained by the secured resource from the user datastore. Location schedules may also be obtained by the secured resource from the user datastore. The user datastore may provide a map of location and schedules to the secured resource. The user's location may be examined to determine if it falls within an approved geospatial rectangle, an approved point-radius, or within the bounds of any restrained area. The location of the user may also be compared with the user's local time to determine if the user is trying to achieve access within an approved, defined time range from that location. For example, intervals of time may be associated with a user and with a location such that a user cannot bypass the multi-factor authentication if they are not within the approved time window at a particular location. In an example, an employee may work from their office location between the hours of 9:30 AM and 7:30 PM on weekdays only. The employee may work from home anytime between 9 AM and 1:30 PM on weekdays on occasion. Outside of these time windows at the office and at home, the employee would not be able to bypass the multi-factor authentication. This determination process is described and illustrated in further detail in FIGS. 3-6 below.

In operation 220, the user is determined to be within the authorized space-time region and the user is successfully logged-in.

In operation 225, authentication is not successful, factor bypass is denied and the user profile is obtained. The user's location may be determined to be outside of the approved geospatial rectangle and/or outside of the associated schedule range. As a result, the secured resource obtains the user's profile from the user datastore. The user profile may contain an object such as a mobile number or email address. Control is passed to operation 230 and process 200 continues.

In operation 230, an authentication token is generated and sent to the user. In an embodiment, the authentication token may be generated by the secured resource. The secured resource sends a persistent authentication token to the user datastore. A message such as an SMS or email may also be sent to a service (e.g., SMS service) to be transmitted to the contact information previously provided by the user. The message, containing the generated authentication token, is received by the user at their previously indicated device. Control is passed to operation 235 and process 200 continues.

In operation 235, it is determined whether or not the token is valid. If it is determined that the token is valid, control is passed to operation 220, the user is successfully logged-on, and the process 200 continues. If it is determined that the token is not valid, control is passed to operation 240 and the process continues.

The determination in operation 235 may be based on any suitable criteria. For example, after the User has received the authentication token via SMS or email or other suitable means. The token is submitted to the secured resource, by the user, and compared with the persistent authentication token previously generated.

In operation 240, the user is denied access.

FIG. 3 is a diagram illustrating an embodiment of multi-factor authentication, indicated generally at 300, with context-dependent factor bypass. An embodiment of an authenticated geolocation-enhanced multi-factor authentication network is illustrated for a mobile device in FIG. 3. A plurality of means for geolocation may be used in the system 300. In an embodiment, GPS-based determination may be used for low-resolution positioning while IP address-driven geolocation for Wi-Fi-connected devices and ultra-low resolution positions may be used. Alternatively, a combination of GPS-based geolocation and IP address-driven geolocation (such as Google Location technologies) for resolution location determination may also be used.

The mobile device 305 may comprise a smartphone or other type of mobile device of a user that is equipped with GPS technology or other global positioning technology. In an embodiment, the mobile device 305 receives signals 306 from a satellite 315 and a mobile network 310. The signals 306 may be combined to triangulate the position of the user via the mobile device. The mobile device 305 sends an authentication request 307 to the authentication service 320. The authentication service 320 may comprise a web service, such as a ReST API or other similar service, which gathers data about a user (e.g., the user's location). The authentication request 307 may comprise the user credentials and the triangulated position of the device 305. The Authentication Service 320 retrieves the user's profile, authorized locations, and any schedule restrictions from a database 325 and determines if these meet the access criteria for the user. An authentication response 322 is sent to the user's mobile device 305 and additional factors may be bypassed to allow the user access.

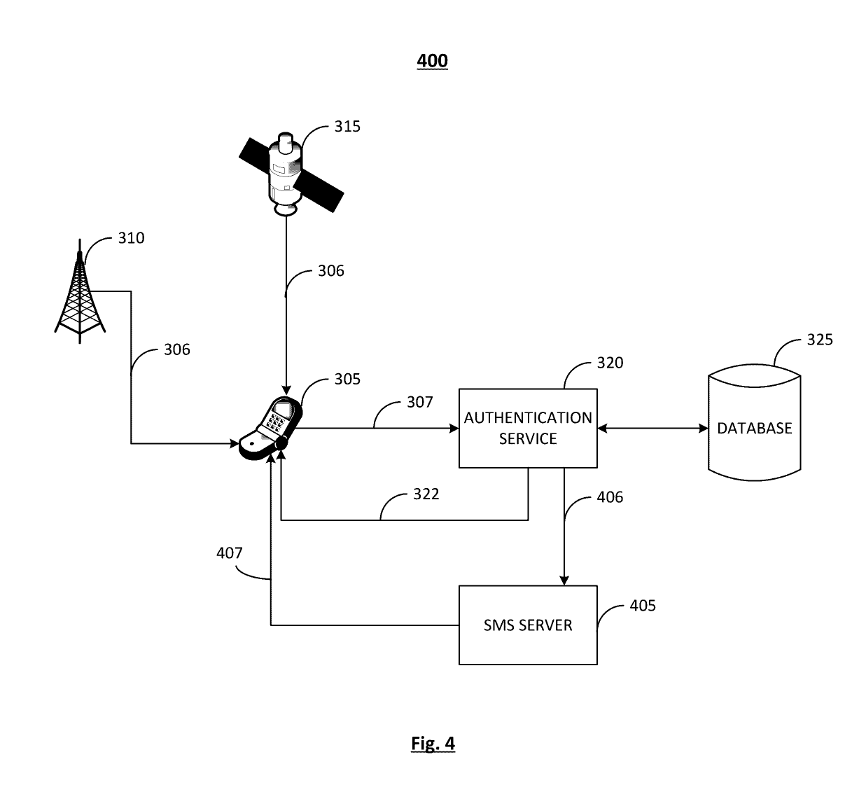

FIG. 4 is a diagram illustrating an embodiment of multi-factor authentication, indicated generally at 400. In this example of an embodiment, failure to meet the qualifications for factor bypass has occurred with fallback to multi-factor authentication behavior. This diagram is similar that described in FIG. 3, except that the authentication service 320 has determined that the user is not accessing the secured resource in a context that authorizes the user to bypass the authentication of one or more additional factors. The authentication service 320 sends a message 406, such as email or SMS to the contact information the user profile, which contains an authentication token from the SMS server 405. The SMS server 405 transmits the information 407 to the user's mobile device 305. The user is requested to enter and submit the token to the authentication server. At this point, multi-factor authentication flow may begin until the user has been authenticated and allowed access.

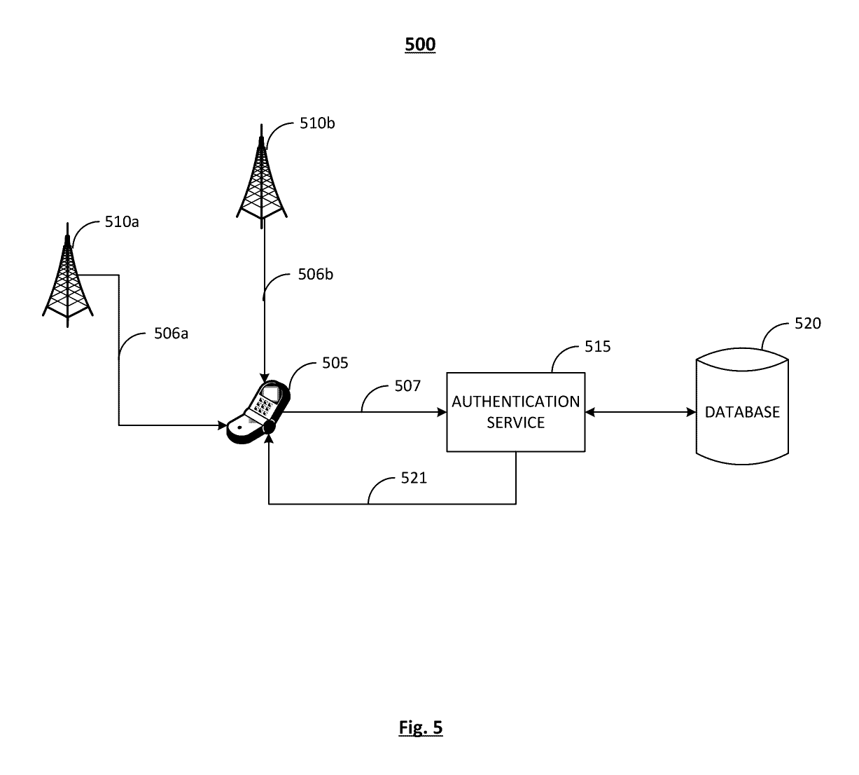

FIG. 5 is a diagram illustrating an embodiment of multi-factor authentication, indicated generally at 500 with context-dependent factor bypass. Another embodiment may use a transmitter for positioning, instead of GPS, such as signals placed within an office space. An example of the transmitter may be an iBeacon strategically placed throughout an office environment. In FIG. 5, two transmitters are illustrated for simplicity, although any number may be used. In an example, transmitter 510a may be located on the first floor of a corporate office while transmitter 510b is located on the second floor of the corporate office. The transmitters 510a and 510b convey packet broadcasts 506a and 506b to a user's mobile device 505, which are used to determine the location of the mobile device 505. In an example, the iBeacons may be used to position a user's device 505 within the office. The user's mobile device 505 transmits an authentication request 507 to the authentication service 515. The authentication request 507 may contain the user's credentials and the array of transmitter IDs/proximities. The authentication service 515 retrieves information about the user and the device, such as the user profile, authorized transmitter metadata, and schedule restrictions of the user, from a database 520 and sends the authentication response 521 to the user's mobile device 505.

Other examples of transmitters may include those that incorporate Bluetooth LE/Bluetooth SMART protocols or any other such device that utilizes near-field, high resolution point-radius determination or geometric triangulation determination. Where laptops and/or desktops are present in an enterprise environment, IP address-driven geolocation or Wi-Fi Access Point identification may be used or a combination of the two, for example.

For highly secure applications, multiple location validation schemes may be utilized. In an embodiment, an office may need to secure applications to only allow bypass by employees working in a certain department, when located on a certain floor and working in conference rooms on another floor. Transmitters may be utilized for the mobile devices with a fallback to Wi-Fi Access point tracing for devices that do not support communication with transmitters.

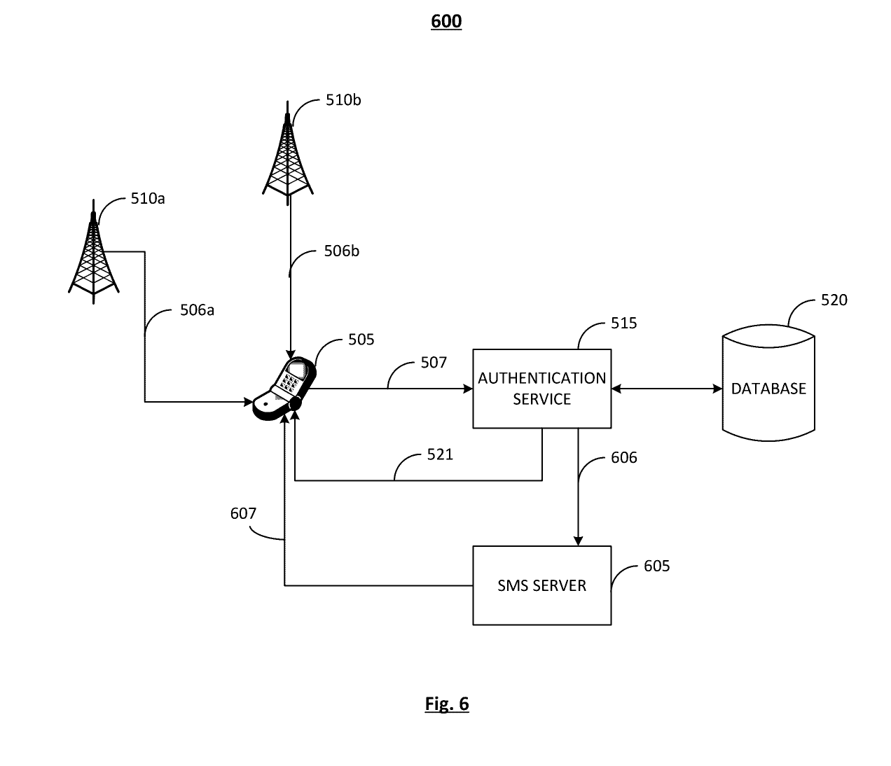

FIG. 6 is a diagram illustrating an embodiment of multi-factor authentication, indicated generally at 600. In this example of an embodiment, multi-factor authentication has failed. In the event that the authentication service 515 determines that the user must meet additional factors for access, the authentication service 515 invokes sending a message 606, such as email or SMS to the contact information the user profile, which contains an authentication token from the SMS server 605. The SMS server 605 transmits the information 607 to the user's mobile device 505 for the user to enter the token and submit to the authentication server. At this point, multi-factor authentication flow may begin until the user has been authentication and allowed access.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for authenticating a user in a system comprising at least a user, a user device, a secured resource, an authentication service, and a user datastore, the method comprising the steps of:
a. obtaining, by the secured resource from the user, credentials that assert an identity of the user;
b. sending, by the secured resource to the authentication service, the credentials from the device;
c. providing, by the user datastore to the authentication service, an encrypted version of credentials associated with the user in the system and validating, by the authentication service, the credentials that have been entered with the encrypted version of credentials;
d. providing, by the user datastore to the authentication service, previously selected attributes for the user;
e. verifying, by the authentication service, that the user meets criteria of the previously selected attributes, wherein,
i. if the user meets criteria of the previously selected attributes, bypassing further authentication, and
ii. if the user is not within the meets criteria of the previously selected attributes, invoking further authentication.

2. The method of claim 1, wherein the further authentication comprises the steps of:
a. obtaining, by the authentication service from the user datastore, a profile of the user, wherein said profile comprises an endpoint for communication delivery;
b. generating, by the authentication service, an authentication token and persisting the authentication token to the user datastore; and
c. sending, by the authentication service to the endpoint, the authentication token to the user for entry into the secured resource;
d. sending, by the secured resource to the authentication service, the authentication token entered by the user;
e. retrieving, by the authentication service from the user datastore, the persisted authentication token and validating the persisted authentication token with the user entered authentication token.

3. The method of claim 2, wherein said endpoint comprises at least one of: an e-mail address and a phone number.

4. The method of claim 2, wherein said authentication token has been generated randomly.

5. The method of claim 1, wherein the selected attributes comprise one or more of authorized locations and authorized schedules.

6. The method of claim 5, wherein the authorized locations comprise at least one of: authorized locations for the device and authorized locations for the credentials.

7. The method of claim 5, wherein the authorized schedules comprise authorized schedules for the location, authorized schedules for the device, and authorized schedules for the credentials.

8. The method of claim 5, wherein the device is GPS-enabled.

9. The method of claim 5, wherein the device is network-connected.

10. The method of claim 5, wherein the device comprises one of: a mobile device, a laptop, a smartphone, and a PDA.

11. The method of claim 5, wherein the selected attributes identify eligibility of a user to bypass further authentication.

12. A method for authenticating a user in a system comprising at least a user, a device, a secured resource, an authentication service, a user datastore, and a transmitter, the method comprising the steps of:
a. obtaining, by the secured resource from the user, credentials that assert an identity of the user;
b. sending, by the secured resource to the authentication service, the credentials from the device;
c. providing, by the user datastore to the authentication service, an encrypted version of credentials associated with the user and validating, by the authentication service, the credentials that have been entered with the encrypted version of credentials;
d. providing, by the user datastore to the authentication service, attributes for the user;
e. verifying, by the authentication service with the transmitter, the attributes for the user, wherein,
i. if the user meets criteria for the attributes, bypassing further authentication, and
ii. if the user does not meet criteria for the attributes, invoking further authentication.

13. The method of claim 12, wherein the further authentication comprises the steps of:
a. obtaining, by the authentication service from the user datastore, a profile of the user, wherein said profile comprises an endpoint for communication delivery;
b. generating, by the authentication service, an authentication token and persisting the authentication token to the user datastore; and
c. sending, by the authentication service to the endpoint, the authentication token to the user for entry into the secured resource;
d. sending, by the secured resource to the authentication service, the authentication token entered by the user;
e. retrieving, by the authentication service from the user datastore, the persisted authentication token and validating the persisted authentication token with the user entered authentication token.

14. The method of claim 13, wherein said endpoint comprises at least one of: an e-mail address and a phone number.

15. The method of claim 13, wherein said authentication token has been generated randomly.

16. The method of claim 12, wherein the transmitter comprises geometric triangulation determination.

17. The method of claim 14, wherein the attributes for the user comprise at least one of: authorized locations and authorized location schedules.

18. The method of claim 17, wherein the selected attributes identify eligibility of a user to bypass further authentication.

19. The method of claim 17, wherein the authorized locations comprise authorized locations for the device and authorized locations for the credentials.

20. The method of claim 17, wherein the authorized schedules comprise authorized schedules for the location, authorized schedules for the device, and authorized schedules for the credentials.

21. The method of claim 12, wherein the transmitter comprises near-field, high-resolution point-radius determination.

22. The method of claim 20, wherein the device comprises a mobile device.

23. The method of claim 19, wherein the device comprises a portable computing device.

24. The method of claim 12, wherein the transmitter comprises at least one of: IP address-driven geolocation and Wi-Fi Access Point identification.

25. The method of claim 24, wherein the device comprises a portable computing device.

26. The method of claim 24, wherein the device comprises a desktop computing device.
